(19) United States
(12) Patent Application Publication
(10) Pub. No.: US 2020/0165964 A1
(43) Pub. Date: May 28, 2020

(54) AIR COOLING DEVICE

(71) Applicant: DENSO CORPORATION, Kariya-city (JP)

(72) Inventors: Shota TERACHI, Kariya-city (JP); Akira YAMANAKA, Kariya-city (JP); Michiya TAKATSUKA, Kariya-city (JP)

(21) Appl. No.: 16/780,635

(22) Filed: Feb. 3, 2020

Related U.S. Application Data
(63) Continuation of application No. PCT/JP2018/023742, filed on Jun. 22, 2018.

(30) Foreign Application Priority Data
Aug. 10, 2017 (JP) 2017-155151

(51) Int. Cl. F02B 29/04; F02M 35/10

(52) U.S. Cl. CPC F02B 29/0412; F02M 35/10209; F02B 29/0462

(57) ABSTRACT

An air cooling device includes a first inlet surge tank, a first heat exchanger to cool air introduced from the first surge tank, a second inlet surge tank, a second heat exchanger to cool air introduced from the second surge tank, and an outlet surge tank. The outlet surge tank receives both of airs introduced from the first heat exchanger and the second heat exchanger and the airs flows from the outlet surge tank toward an internal combustion engine. The outlet surge tank includes a merging space and a fixing hole. The merging space is where the airs introduced from the first heat exchanger and the second heat exchanger merge with each other. A fastening member to fasten the outlet surge tank passes through the fixing hole from an outer surface of the outlet surge tank away from the merging space toward the internal combustion engine.

### CROSS REFERENCE TO RELATED APPLICATION

The present application is a continuation application of International Patent Application No. PCT/JP2018/023742 filed on Jun. 22, 2018, which designated the U.S. and claims the benefit of priority from Japanese Patent Application No. 2017-155151 filed on Aug. 10, 2017. The entire disclosures of all of the above applications are incorporated herein by reference.

### TECHNICAL FIELD

The present disclosure relates to an air cooling device to cool air supplied to an internal combustion engine in a vehicle.

### BACKGROUND

A vehicle includes a supercharger and an air cooling device to cool high-temperature air compressed by the supercharger before the air is supplied to an internal combustion engine.

### SUMMARY

According to an aspect of the present disclosure, an air cooling device cools air supplied to an internal combustion engine of a vehicle. The air cooling device includes a first inlet surge tank to receive air, a first heat exchanger, a second inlet surge tank to receive air, a second heat exchanger, and an outlet surge tank. The first heat exchanger allows the air introduced from the first inlet surge tank to exchange heat with cooling water and be cooled. The second heat exchanger allows the air introduced from the second inlet surge tank to exchange heat with the cooling water and be cooled. The outlet surge tank receives both of the air cooled in the first heat exchanger and the air cooled in the second heat exchanger, and the airs flow out of the outlet surge tank toward the internal combustion engine. The outlet surge tank includes a merging space where the air introduced from the first heat exchanger merges with the air introduced from the second heat exchanger inside the outlet surge tank. The outlet surge tank has a fixing hole through which a fastening member passes to fasten the outlet surge tank to the vehicle. The fastening member passes through the outlet surge tank from an outer surface of the outlet surge tank located away from the merging space.

### BRIEF DESCRIPTION OF THE DRAWINGS

FIG. 1 is a perspective view illustrating an air cooling device according to a first embodiment.

FIG. 2 is a top view of the air cooling device in FIG. 1.

FIG. 3 is a side view of the air cooling device in FIG. 1.

FIG. 4 is a bottom view of the air cooling device in FIG. 1.

FIG. 5 is a schematic view illustrating the air cooling device disposed on an internal combustion engine.

FIG. 6 is a cross-sectional view taken along a line VI-VI in FIG. 2.

FIG. 7 is an enlarged view of an A part in FIG. 6.

FIG. 8 is a perspective view illustrating an air cooling device according to a second embodiment.

### DETAILED DESCRIPTION

To begin with, examples of relevant techniques will be described.

A vehicle includes a supercharger and an air cooling device to cool high-temperature air compressed by the supercharger before the air is supplied to the internal combustion engine.

The air cooling device includes a heat exchanger, and an inlet surge tank and an outlet surge tank that are respectively disposed at both sides of the heat exchanger. The heat exchanger is a component in which air exchanges heat with cooling water and is cooled. The inlet surge tank is a member to introduce air that is to be cooled into the heat exchanger. The outlet surge tank is a member to introduce the air cooled by the heat exchanger into the internal combustion engine. Each of the inlet surge tank and the outlet surge tank is fixed to the heat exchanger by fixing a flange of the tank with a bolt.

In to say V type engine, two superchargers are disposed respectively on a right side and a left side of an internal combustion engine, and two heat exchangers for cooling air are usually provided corresponding to the two superchargers. The air cooling device is configured such that air cooled by each of the heat exchangers is separately supplied to cylinders without merging with each other. In such configuration, a temperature and a flow rate of air supplied cylinders may vary among cylinders. As a result, issues such as reduction in an output of the internal combustion engine, a deterioration of fuel efficiency, and the like may occur.

The present disclosure provides an air cooling device capable of reducing a variation in temperature and flow rate of air supplied to each cylinder even while including multiple heat exchangers.

According to an aspect of the present disclosure, an air cooling device cools air supplied to an internal combustion engine of a vehicle. The air cooling device includes a first inlet surge tank to receive air, a first heat exchanger, a second inlet surge tank to receive air, a second heat exchanger, and an outlet surge tank. The first heat exchanger allows the air introduced from the first inlet surge tank to exchange heat with cooling water and be cooled. The second heat exchanger allows the air introduced from the second inlet surge tank to exchange heat with the cooling water and be cooled. The outlet surge tank receives both of the air cooled in the first heat exchanger and the air cooled in the second heat exchanger and the airs flow out of the outlet surge tank toward the internal combustion engine. The outlet surge tank includes a merging space where the air introduced from the first heat exchanger merges with the air introduced from the second heat exchanger inside the outlet surge tank. The outlet surge tank has a fixing hole through which a fastening member passes to fasten the outlet surge tank to the vehicle. The fastening member passes through the outlet surge tank from an outer surface of the outlet surge tank located away from the merging space.

In the air cooling device having such configuration, the air introduced to the outlet surge tank from the first heat exchanger and the second heat exchanger merge with each other briefly in the merging space formed inside the outlet surge tank. The merged air is distributed and supplied to cylinders. That is, air from the merging space that is a single space is supplied to the cylinders, thereby reducing a variation in temperature and flow rate of air supplied to the cylinders.

According to the present disclosure, an air cooling device capable of reducing a variation in temperature and flow rate of air supplied to the cylinders even while including multiple heat exchangers is provided.

Hereinafter, embodiments in the present disclosure will be described with reference to attached figures. The same symbols are assigned to the same components in each figure as well as possible, and redundant explanations are omitted to facilitate understanding of the description.

An air cooling device 10 according to a first embodiment will be described.

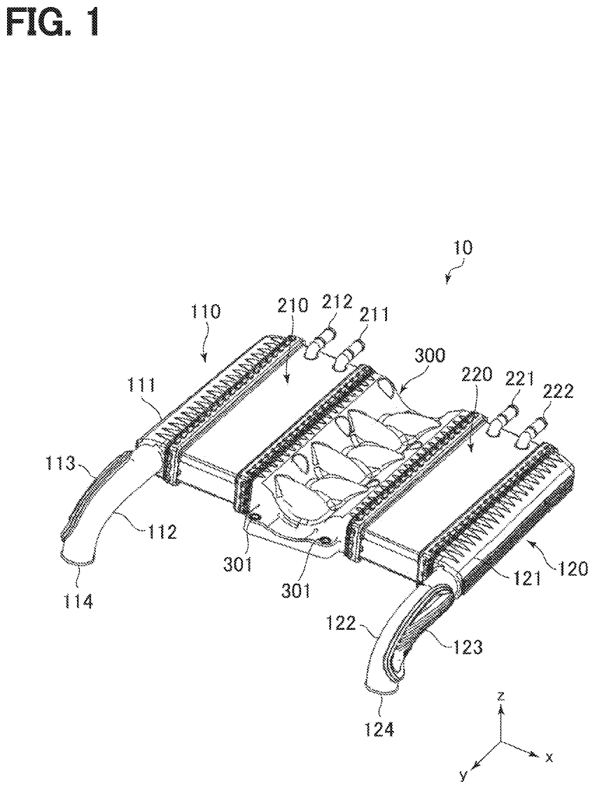

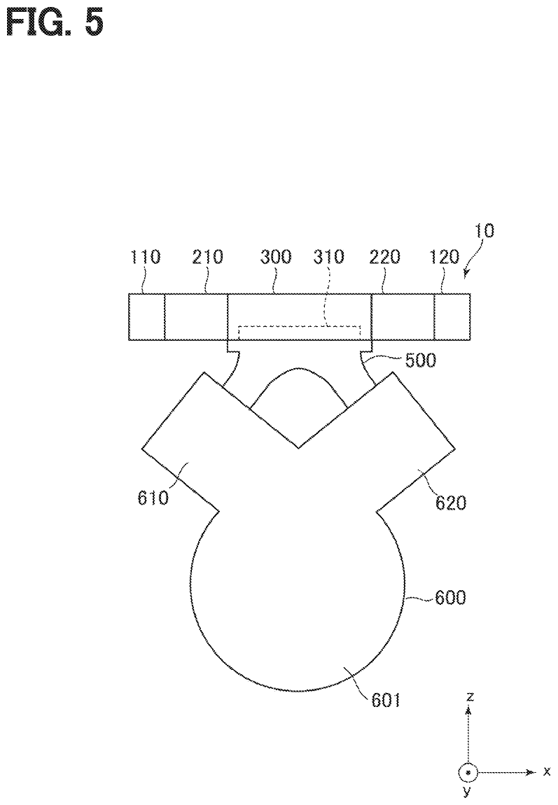

The air cooling device 10 cools high-temperature air discharged from a supercharger of a vehicle (not shown) before supplied to an internal combustion engine 600 (see FIG. 5). As shown in FIG. 1, the air cooling device 1 includes a first inlet surge tank 110, a first heat exchanger 210, a second inlet surge tank 120, a second heat exchanger 220, and an outlet surge tank 300.

The first inlet surge tank 110 receives the high-temperature air discharged from the supercharger. The first inlet surge tank 110 includes a pipe 112 and a body 111.

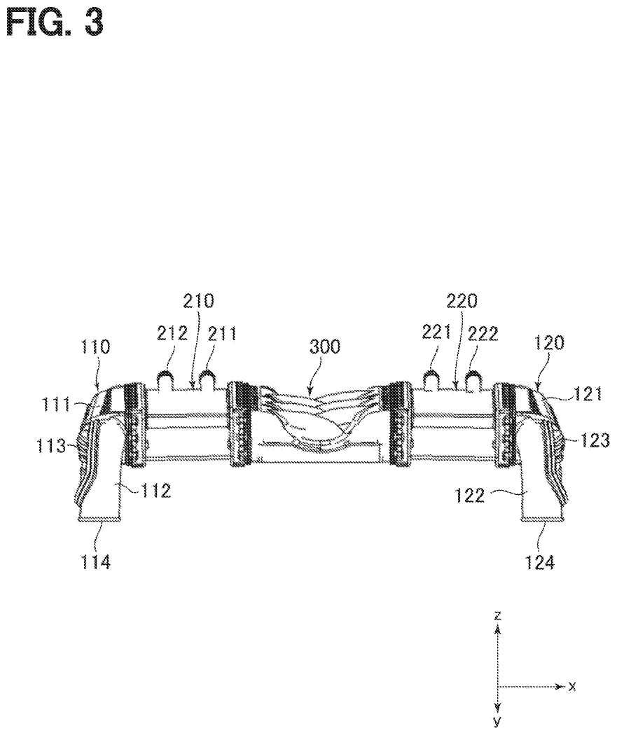

The pipe 112 is formed to have a substantial cylindrical shape and introduces the air from the supercharger to the body 111. The pipe 112 includes an opening 114 that is an air inlet at an upstream end of the pipe 112. As shown in FIG. 3, the pipe 112 is a curved pipe such that the opening 114 faces downward.

The body 111 is a container to briefly receive the air having passed through the pipe 112 and supply the air to the first heat exchanger 210. The body 111 is configured as a container having a linear shape along a side surface of the first heat exchanger 210. The body 111 includes a side surface extended along a longitudinal direction of the body 111. The side surface facing the first heat exchanger 210 has an opening on approximately the whole portion of the side surface of the body 111, and is connected to the first heat exchanger 210 with the opening.

The first inlet surge tank 110 having such configuration is made of resin as a whole. The pipe 112 includes an opening just after molding the first inlet surge tank 110. The opening is covered with a cover 113 that is a different member that is made of resin. The pipe 112 and the cover 113 are joined by welding. Such configuration allows molding the first inlet surge tank 110 having a complex shape.

The first heat exchanger 210 is a heat exchanger in which the air introduced from the first inlet surge tank 110 exchanges heat with cooling water and is cooled. The first heat exchanger 210 is connected to an inlet pipe 211 to receive the cooling water and an outlet pipe 212 from which the cooling water flowing out. The first heat exchanger 210 includes multiple plates (not shown) defining a passage through which the cooling water flows. The multiple plates are layered in the first heat exchanger 210. The cooling water supplied from the inlet pipe 211 is heated by air passing through outside the passage during flowing through the passage between the multiple plates. In contrast, the high-temperature air supplied to the first heat exchanger from the first inlet surge tank 110 is cooled by the cooling water flowing through the passage and then supplied to the outlet surge tank 300 described later.

The first heat exchanger 210 is connected to a side surface of the outlet surge tank 300 as shown in FIG. 1. A different side surface of the outlet surge tank 300 is connected to the second heat exchanger 220 described later.

The second inlet surge tank 120 receives the high-temperature air discharged from a different supercharger as with the first inlet surge tank 110. The vehicle includes two superchargers. Air discharged by one of the two superchargers is supplied to the first inlet surge tank 110 and air discharged by the other of the two superchargers is supplied to the second inlet surge tank 120. The second inlet surge tank 120 includes a pipe 122 and a body 121.

The pipe 122 is formed to have a substantially cylindrical shape and introduces the air from the supercharger to the body 121. The pipe 122 includes an opening 124 that is an air inlet at an upstream end of the pipe 122. As shown in FIG. 3, the pipe 122 is a curved pipe such that the opening 124 faces downward.

The body 121 is a container to briefly receive the air passing through the pipe 122, and to supply the air to the second heat exchanger 220. The body 121 includes a side surface extending along a longitudinal direction of the body 121. The side surface facing the second heat exchanger 220 has an opening on approximately the whole portion of the side surface of the body 121, and is connected to the second heat exchanger 220. In this embodiment, the longitudinal direction of the body 111 and the longitudinal direction of the body 121 are parallel with each other.

The second inlet surge tank 120 having such configuration is made of resin as a whole. The pipe 122 includes an opening just after molding the second inlet surge tank 120. The opening is covered with a cover 123 that is a different member made of resin. The pipe 122 and the cover 123 are joined by welding. Such configuration allows molding the second inlet surge tank 120 having a complex shape.

The second heat exchanger 220 is a heat exchanger in which the air introduced from the second inlet surge tank 120 exchanges heat with the cooling water and is cooled. The second heat exchanger 220 is connected to an inlet pipe 221 to receive the cooling water and an outlet pipe 222 through which the cooling water flows out. The second heat exchanger 220 includes multiple plates (not shown) defining a passage through which the cooling water flows. The multiple plates are layered in the second heat exchanger 220. The cooling water supplied from the inlet pipe 221 is heated by the air traveling outside the passage during flowing through the passage between the multiple plates. On the other hand, the high-temperature air supplied to the second heat exchanger 220 from the second inlet surge tank 120 is cooled by the cooling water flowing through the passage and then supplied to the outlet surge tank 300.

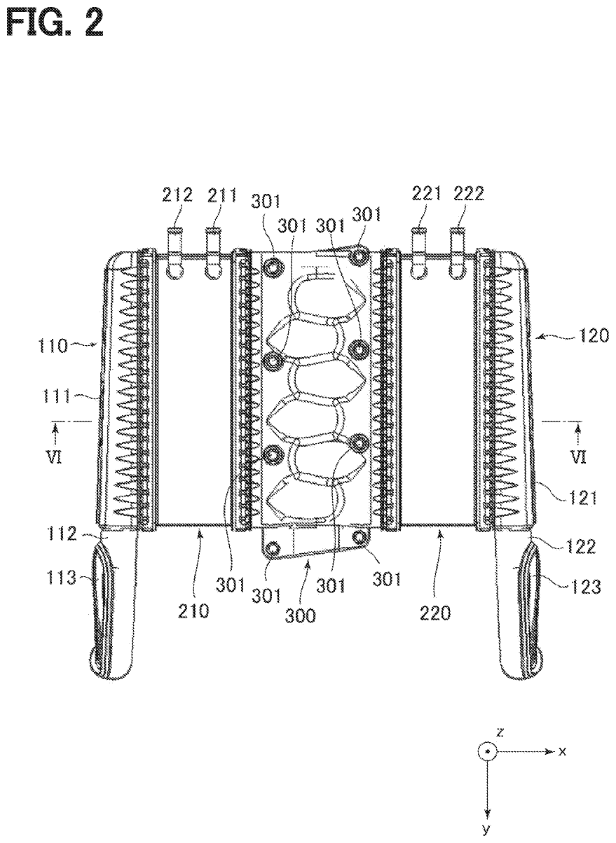

In FIG. 1, a direction from the first inlet surge tank 110 to the second inlet surge tank 120 is defined as a x direction, and a x axis is defined along the x direction. A longitudinal direction of the body 111, 121 is defined as a y direction, and a y axis is defined along the y direction. Air flows in the body 111, 121 in an direction opposite to the y direction. A direction that is orthogonal to the x axis and the y axis and vertically upward is defined as a z direction, and a z axis is defined along the z direction. In FIGS. 2 to 8, the x axis, the y axis, and the z axis are defined as described above.

The outlet surge tank 300 receives the air cooled in the first heat exchanger 210 located on one side (−x) of the outlet surge tank 300 and the air cooled in the second heat exchanger 220 located on an opposite side (+x) of the outlet surge tank 300, and the airs flow out of the outlet surge tank 300 toward the internal combustion engine 600 located downward.

As shown in FIG. 5, a lower portion of the outlet surge tank 300 (i.e., a portion located closer to the internal combustion engine 600 in the z direction) includes a merging space 310. The merging space 310 is a single space where the air flowing from the first heat exchanger 210 and the air flowing from the second heat exchanger 220 merge with each other. As shown in FIG. 1, the outlet surge tank 300 has first connectors connecting the first heat exchanger 210 to the merging space 310 and second connectors connecting the second heat exchanger 220 to the merging space 310. The first connectors and the second connectors extend in the x direction in which the first inlet surge tank 110, the first heat exchanger 210, the outlet surge tank 300, the second heat exchanger 220, and the second inlet surge tank 120 are connected in this order. The first connectors and the second connectors are alternately arranged in the y direction, and overlap with the merging space 310 in the z direction.

As shown in FIG. 2, the outlet surge tank 300 includes multiple fixing holes 301. Each of the fixing holes 301 is a through hole in which a fastening member such as a bolt to fasten the outlet surge tank 300 to the vehicle is inserted. The fastening member is inserted toward the internal combustion engine 600 from an outer surface of the outlet surge tank 300 that is opposite to the internal combustion engine 600. The fastening member passes through the fixing hole 301 defined from an upper outer surface of the outer surge tank 300 to a lower outer surface of the outlet surge tank 300 that is closer to the internal combustion engine 600. Each of the fixing holes 301 passes through the outlet surge tank 300 along the z axis. A peripheral portion around the fixing hole 301 is entirely sealed with resin, thus the air in the merging space 310 does not leak from the fixing hole 301.

In FIG. 5, the air cooling device 10 mounted in a vehicle is schematically illustrated. The internal combustion engine 600 of the vehicle is configured as so-called “V-type engine” and includes a crankcase 601, a first cylinder group 610, and a second cylinder group 620. In the first cylinder group 610, multiple cylinders are arranged in the y direction and oriented outward (−x) in the x direction in an upper space of the crankcase 601. As with the same, in the second cylinder group 620, multiple cylinders are arranged in the y direction and oriented outward (+X) in the x direction in the upper space of the crankcase 601. A public known configuration may be applied as the internal combustion engine 600 that is a V-type engine, thus specific explanations and illustrations are omitted.

The air cooling device 10 is connected to each cylinder of the internal combustion engine 600 through an intake manifold 500. The intake manifold 500 forms a passage therein to distribute the air flowing out of the outlet surge tank 300 of the air cooling device 10 to cylinders.

The outlet surge tank 300 is fixed to the intake manifold 500 with a bolt inserted in the above-mentioned fixing hole 301 from an upper side of the fixing hole 301, and the air cooling device 10 is thereby entirely fixed to an upper side of the internal combustion engine 600.

As a configuration to fix the outlet surge tank 300 to the intake manifold 500, for example, flanges may be respectively formed on a bottom end of the outlet surge tank 300 and an upper end of the intake manifold 500. The outlet surge tank 300 and the intake manifold 500 may be fixed with a bolt passing through the flanges while the flanges are fitted. However, in such configuration, a space for fixing cannot be secured unless the outlet surge tank 300 is fixed to the intake manifold 500 at first and then the first heat exchanger 210 and the second heat exchanger 220 are attached to the outlet surge tank 300. Thus, a vehicle manufacturer needs to assemble the air cooling device 10.

In contrast, in the air cooling device 10 according to the embodiment, the fastening member is inserted from the upper outer surface of the outlet surge tank 300 away from the merging space 310 and fastens the outlet surge tank 300 to the intake manifold 500. Thus, the first heat exchanger 210, the second heat exchanger 220, and the like are mounted to the outlet surge tank 300 in advance, and then the air cooling device 10 can be fixed to the intake manifold 500. For example, a vehicle manufacturer can purchase the air cooling device 10 that is completely assembled and mount the assemble-completed air cooling device 10 on the vehicle. Thus, steps for the assembly in the vehicle manufacture can be reduced.

With reference to FIGS. 1 and 5, a flow of air in the air cooling device 10 will be described. The high-temperature air discharged by one of the two superchargers flows into the pipe 112 of the first inlet surge tank 110 through the opening 114. After that, the air flows through the body 111 along the y direction and enters in the first heat exchanger 210.

The air supplied to the first heat exchanger 210 flows along the x direction in the first heat exchanger 210 and is cooled by the cooling water. After that, the air flows into the merging space 310 of the outlet surge tank 300.

The high-temperature air discharged by the other of the two superchargers flows into the pipe 122 of the second inlet surge tank 120 through the opening 124. After that, the air flows along the y direction in the body 121 and enters into the second heat exchanger 220.

The air supplied to the second heat exchanger 220 flows along the x direction in the second heat exchanger 220 and is cooled by the cooling water. After that, the air flows into the merging space 310 of the outlet surge tank 300.

In the merging space 310, the air flowing from the first heat exchanger 210 and the air flowing from the second heat exchanger 220 are joined and mixed with each other. The air flows into the intake manifold 500 located below the merging space 310 and is distributed to cylinders in the first cylinder group 610 and the second cylinder group 620.

As described above, in the air cooling device 10, the air flowing into the outlet surge tank 300 from the first heat exchanger 210 and the air flowing into the outlet surge tank 300 from the second heat exchanger 220 merge briefly in the merging space 310 formed inside the outlet surge tank 300. The merged air is distributed to cylinders. The air is supplied to cylinders from the merging space 310 that is a single space, thereby reducing variations in temperature and flow rate of air among the cylinders.

In this embodiment, a shape of the first inlet surge tank 110 and a shape of the second inlet surge tank 120 are substantially symmetrical relative to a y-z plane. Similarly, a shape of the first heat exchanger 210 and a shape of the second heat exchanger 220 are substantially symmetrical relative to the y-z plane. Thus, a flow rate and a temperature of air flowing into the outlet surge tank 300 from the first heat exchanger 210 are nearly the same with a flow rate and a temperature of air flowing into the outlet surge tank 300 from the second heat exchanger 220, thereby further reducing the variations in the temperature and the flow rate of air supplied to cylinders.

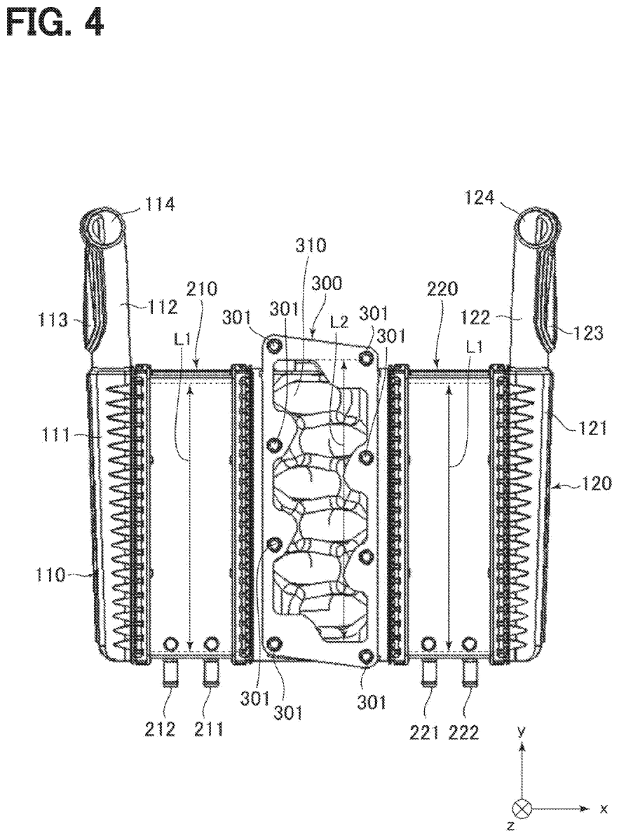

As shown in FIG. 4, when a width of the passage through which air flows in the first heat exchanger 210 and a width of the passage through which air flows in the second heat exchanger 220 along a front-rear direction of the vehicle (i.e., the y direction) is defined as a width L1 and a width of the merging space 310 in the same direction is defined as a width L2, the width L1 is nearly the same with the width L2. Thus, when air flowing in the first heat exchanger 210 in the x direction flows into the merging space 310, the widths of the passage of the first heat exchanger 210 and the passage of the merging space 310 are almost the same and the flow of air flowing therein is not interfered largely. Similarly, when air flowing in the second heat exchanger 220 in the x direction flows into the merging space 310, the widths of the passage of the second heat exchanger 220 and the passage of the merging space 310 are almost the same and thus the flow of air flowing therein is not interfered largely. Therefore, a flow rate of the air supplied to the cylinders is prevented from increasing, decreasing greatly, and varying among the cylinders, thereby further reducing the variations in the flow rate of the air supplied to cylinders.

The width L1 and the width L2 are not necessary the same value. According to examinations by inventors, the above-described effect can be obtained while the width L1 falls within a range of 80% to 120% of the width L2.

In this embodiment, a flow direction of air changes gently at a connecting portion between the body 111 and the pipe 112. Thus, the direction in which air flows in the first inlet surge tank 110 is along a connecting portion between the first inlet surge tank 110 and the first heat exchanger 210 (i.e., air flows in the first inlet surge tank 110 in the direction opposite to they direction).

Similarly, the flow direction of air changes gently at a connecting portion between the body 121 and the pipe 122. Therefore, the direction in which the air flows in the second inlet surge tank 120 is along a connecting portion between the second inlet surge tank 120 and the second heat exchanger 220 (i.e., air flows in the second inlet surge tank 120 in the direction opposite to they direction).

For example, compared to a configuration in which the pipe 112 is vertically connected to the body 111, according to this embodiment, the flow of air is restricted from suddenly changing in the flow direction in the first inlet surge tank 110 and from being disturbed. Thus, the variation in the flow rate of the air supplied to cylinders due to the disturbance of the flow of air is further prevented.

When the first inlet surge tank 110 and the like have such configuration described above, the pipe 112 needs to be curved downward for treating in the vehicle. As a result, a shape of the first inlet surge tank 110 may be complex.

However, as described before, the first inlet surge tank 110 in this embodiment is formed by welding multiple elements (the pipe 112 and the cover 113). The second inlet surge tank 120 is formed by welding multiple elements (the pipe 122 and the cover 123). Therefore, the first inlet surge tank 110 and the like having a complex shape can be formed easily.

At least one of the first inlet surge tank 110 and the second inlet surge tank 120 may be formed by welding multiple elements. The first inlet surge tank 110 and the like may be formed by welding three or more elements.

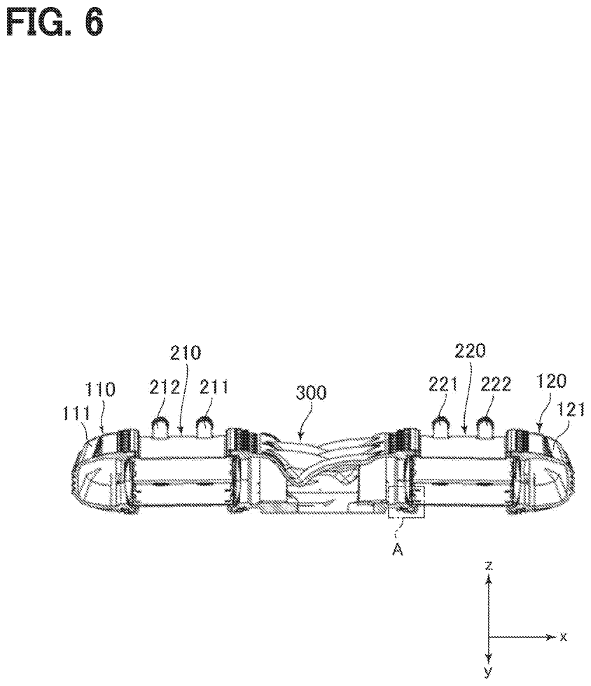

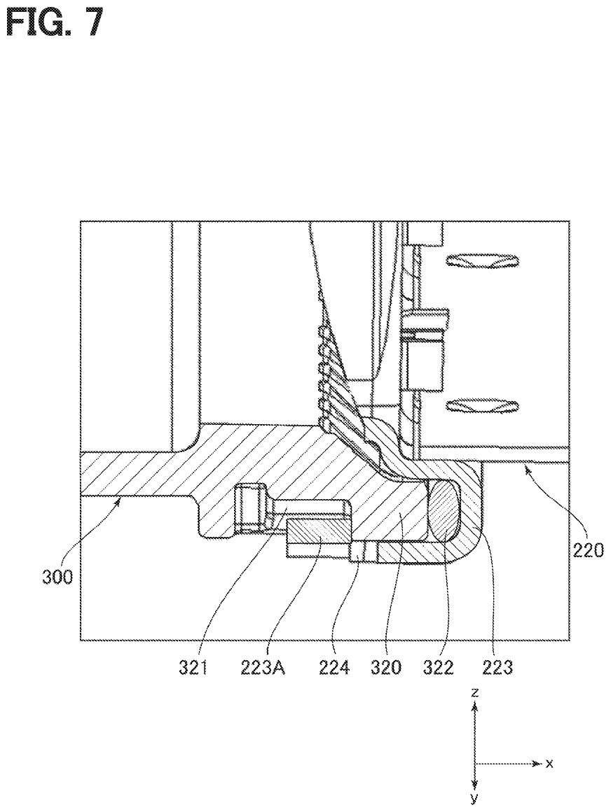

With reference to FIGS. 6 and 7, a configuration of a connecting portion between the second heat exchanger 220 and the outlet surge tank 300 will be explained. An end of the outlet surge tank 300 closer to the second heat exchanger 220 in the x direction includes an outer peripheral end 320. A surface of the outer peripheral end 320 closer to the internal combustion engine 600 in the z direction includes a recess 321 recessed away from the internal combustion engine 600 in the z direction.

An end of the second heat exchanger 220 closer to the outlet surge tank 300 in the x direction includes a caulking plate 223. The caulking plate 223 surrounds the outer peripheral end 320 from an outer side of the outer peripheral end 320 in the x direction and extends along a lower portion of the outer peripheral end 320 in the x direction. A packing 322 is compressed between a tip of the outer peripheral end 320 in the x direction and the caulking plate 223. The packing 322 is an elastic element to prevent air from leaking from the inside of the air cooling device 10.

In the caulking plate 223, a through hole 224 which passes through the caulking plate 223 between two opposite surfaces is formed near the recess 321. The through hole 224 is one of multiple through holes 224 and the multiple through holes are aligned in the y direction. A part of the caulking plate 223 located closer to the recess 321 than the through hole 224 in the x direction is plastically deformed in the z direction, and a part 223A of the caulking plate 223 enters in the recess 321. Thus, the second heat exchanger 220 is fixed to the outlet surge tank 300.

In this embodiment, the fixing configuration with the caulking plate described above is also applied between the first inlet surge tank 110 and the first heat exchanger 210, between the first heat exchanger 210 and the outlet surge tank 300, and between the second inlet surge tank 120 and the second heat exchanger 220. Thus, compared to a configuration in which two flanges are fitted and fixed with bolts, the configuration with the caulking plate allows reducing in size of the connecting parts therebetween (in particular size in the z direction), thereby reducing in entire size of the air cooling device 10. In addition, the configuration with the caulking plate can reduce a number of members such as the bolts.

Not only all but also one or some of parts between the first inlet surge tank 110 and the first heat exchanger 210, the first heat exchanger 210 and the outlet surge tank 300, the second inlet surge tank 120 and the second heat exchanger 220, and the second heat exchanger 220 and the outlet surge tank 300 may have a plastically-deformed part to be fixed with each other.

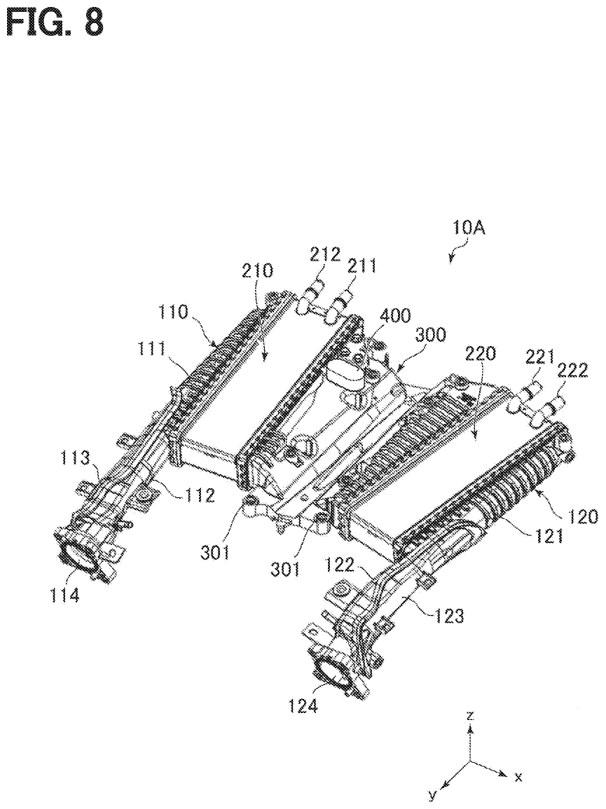

An air cooling device 10A according to a second embodiment will be described with reference to FIG. 8. In following, different portions from the first embodiment are explained and explanations of common portions with the first embodiment are suitably omitted.

In this embodiment, the longitudinal direction of the body 111 of the first inlet surge tank 110 and the longitudinal direction of the body 121 of the second inlet surge tank 120 are not parallel with each other, and a distance between the body 111 and the body 121 gets wider as approaching a downstream side of the air cooling device 10A. If the first inlet surge tank 110 is arranged in such manner, the same effect described in the first embodiment can be obtained.

In this embodiment, a sensor unit 400 is attached to an upper surface of the outlet surge tank 300 (located away from the internal combustion engine 600). The sensor unit 400 is a device to measure a temperature and a pressure of air in the merging space 310. The temperature and the pressure measured by the sensor unit 400 is sent to an ECU (not shown) and utilized to control the internal combustion engine 600.

In a configuration where the air passed through the first heat exchanger 210 and the air passed through the second heat exchanger 220 are supplied to the internal combustion engine 600 without merging with each other, two sensor units 400 are required to measure a temperature and a pressure of each of the airs. In contrast, in this embodiment, the airs merge in the merging space 310 as with in the first embodiment. Thus, one place is enough for measuring the temperature and the pressure of air supplied to the internal combustion engine 600. Accordingly, multiple sensor units 400 are not needed while one sensor unit 400 is provided as with in this embodiment.

The embodiments are described with reference to concrete examples. However, the present disclosure is not limited to these concrete examples. Modifications in designs from these concrete examples by person skilled in the arts are included in the range of the present disclosure as long as including features of the present disclosure. An element, an arrangement, a condition, a shape, and the like thereof included by each concrete example described above are not limited to above-mentioned examples and altered appropriately. Each element included by each concrete example described above can be changed in combinations as long as causing technical contradiction.

What is claimed is:

1. An air cooling device configured to cool air supplied to an internal combustion engine of a vehicle, the device comprising:
a first inlet surge tank configured to receive air;
a first heat exchanger in which the air introduced from the first inlet surge tank exchanges heat with cooling water and is cooled;
a second inlet surge tank configured to receive air;
a second heat exchanger in which the air introduced from the second inlet surge tank exchanges heat with the cooling water and is cooled; and
an outlet surge tank configured to receive both of the airs introduced from the first heat exchanger and the second heat exchanger, the airs flowing out of the outlet surge tank toward the internal combustion engine, wherein
the outlet surge tank includes:
a merging space where the airs introduced from the first heat exchanger and the second heat exchanger merge with each other; and
a fixing hole through which a fastening member passes to fasten the outlet surge tank to the vehicle from an outer surface of the outlet surge tank away from the merging space.

2. The air cooling device according to claim 1, wherein
a width of a passage of the first heat exchanger through which air flows and a width of a passage of the second heat exchanger through which air flows in a front-rear direction of the vehicle fall within a range of 80% to 120% of a width of the merging space in the front-rear direction.

3. The air cooling device according to claim 1, wherein
at least one of parts between the first inlet surge tank and the first heat exchanger, between the first heat exchanger and the outlet surge tank, between the second inlet surge tank and the second heat exchanger, and between the second heat exchanger and the outlet surge tank has a plastically-deformed part to be fixed.

4. The air cooling device according to claim 1, wherein
at least either one of the first inlet surge tank and the second inlet surge tank is formed of a plurality of members by welding.
